(19) United States
(12) Patent Application Publication
(10) Pub. No.: US 2026/0192640 A1
(43) Pub. Date: Jul. 9, 2026

(54) SUNROOF SYSTEM WITH SINGLE MOTOR AND CLUTCH FOR COMBINED SUNROOF GLASS AND SUNSHADE CONTROL

(71) Applicant: GM GLOBAL TECHNOLOGY OPERATIONS LLC, DETROIT, MI (US)

(72) Inventors: Minseok Jeon, Gimpo City (KR); Seonho Park, Bucheon City (KR); Dongwon Lee, Incheon (KR); Seongwon Kim, Incheon (KR)

(21) Appl. No.: 19/010,487

(22) Filed: Jan. 6, 2025

(51) Int. Cl. B60J 7/057; B60J 7/043; F16D 27/02; F16D 27/14; F16D 121/24; F16D 125/46

(52) U.S. Cl. CPC B60J 7/0573; B60J 7/043; F16D 27/02; F16D 27/14; F16D 2121/24; F16D 2125/46

(57) ABSTRACT

A sunroof system for vehicles integrates a single motor and clutch to control both sunroof glass and sunshade. The system includes a motor driving the sunroof glass and sunshade, with a clutch selectively engaging pinions for each component. An electromagnet, positioned on one side of the clutch, moves the clutch between positions to engage with the respective pinions. A spring maintains the clutch in a position for sunshade operation when the electromagnet is deactivated. A processing device aligns grooves on the clutch and pinion gears for smooth transitions.

The subject disclosure relates to vehicles, and in particular to sunroof systems for vehicles.

Automotive systems often utilize multiple mechanisms to control various components. This configuration involves numerous parts and associated electronics. For example, in vehicles equipped with a sunroof system that includes both sunroof glass and a sunshade, two separate motors are used to individually control the sunroof glass and the sunshade.

Accordingly, it is desirable to provide a sunroof system that includes a single motor that is configured to control both the sunroof glass and the sunshade.

### SUMMARY

According to one aspect of the present invention, a system for controlling a sunroof system in a vehicle is provided. The system includes a motor configured to drive a sunroof glass and a sunshade and a clutch operatively connected to the motor. The clutch is configured to selectively engage with a pinion for the sunroof glass and a pinion for the sunshade. The system also includes an electromagnet disposed on one side of the clutch and a spring positioned to maintain the clutch in a first position for sunshade operation when the electromagnet is deactivated. The electromagnet, when activated, moves the clutch to a second position to engage with the pinion for the sunroof glass.

According to another aspect, the system further comprises a processing device that is configured to align one or more grooves on the clutch and pinion gears prior to a movement of the clutch between the first position and second position to ensure smooth transitions between sunroof glass and sunshade operations.

According to yet another aspect, the processing device is configured to obtain data from one or more sensors to detect a position of the clutch.

According to another aspect, the clutch includes a permanent magnet disposed on one end of the clutch.

According to yet another aspect, a strength of an electromagnetic field created by the electromagnet is determined based on an electrical current supplied to the electromagnet.

According to another aspect, the spring is configured to exert a force sufficient to maintain the clutch in the first position while the electromagnet is deactivated.

According to yet another aspect, the clutch is further configured to simultaneously engage with the pinion for the sunroof glass and the pinion for the sunshade while in a third position.

According to another aspect, activating the electromagnet with a first current level moves the clutch to the second position to engage the sunroof glass and activating the electromagnet with a second current level moves the clutch to the third position to engage with the pinion for the sunroof glass and the pinion for the sunshade, wherein the second current level is less than the first current level.

According to yet another aspect, the clutch includes one or more grooves that are configured to receive the pinion for the sunroof glass and the pinion for the sunshade.

According to another aspect, a vehicle having a sunroof system with a sunroof glass, a sunshade, and a control system for controlling the sunroof system is provided. The control system includes a motor configured to drive a sunroof glass and a sunshade and a clutch operatively connected to the motor. The clutch is configured to selectively engage with a pinion for the sunroof glass and a pinion for the sunshade. The system also includes an electromagnet disposed on one side of the clutch and a spring positioned to maintain the clutch in a first position for sunshade operation when the electromagnet is deactivated. The electromagnet, when activated, moves the clutch to a second position to engage with the pinion for the sunroof glass.

According to yet another aspect, the control system further comprises a processing device that is configured to align one or more grooves on the clutch and pinion gears prior to a movement of the clutch between the first position and second position to ensure smooth transitions between sunroof glass and sunshade operations.

According to another aspect, the processing device is configured to obtain data from one or more sensors to detect a position of the clutch.

According to yet another aspect, the clutch includes a permanent magnet disposed on one end of the clutch.

According to another aspect, a strength of an electromagnetic field created by the electromagnet is determined based on an electrical current supplied to the electromagnet.

According to yet another aspect, the spring is configured to exert a force sufficient to maintain the clutch in the first position while the electromagnet is deactivated.

According to another aspect, the clutch is further configured to simultaneously engage with the pinion for the sunroof glass and the pinion for the sunshade while in a third position.

According to yet another aspect, activating the electromagnet with a first current level moves the clutch to the second position to engage the sunroof glass and activating the electromagnet with a second current level moves the clutch to the third position to engage with the pinion for the sunroof glass and the pinion for the sunshade, wherein the second current level is less than the first current level.

According to another aspect, the clutch includes one or more grooves that are configured to receive the pinion for the sunroof glass and the pinion for the sunshade.

According to yet another aspect, a system for controlling a sunroof system in a vehicle is provided. The system includes a motor configured to drive a sunroof glass and a sunshade and a clutch operatively connected to the motor. The clutch is configured to selectively engage with a pinion for the sunroof glass and a pinion for the sunshade. The system also includes an electromagnet disposed on one side of the clutch and a processing device configured to control a current supplied to the electromagnet, where the electromagnetic field created by the electromagnet interacts with the clutch to control a position of the clutch.

According to another aspect, the processing device is configured to selectively place the clutch into one of a first position wherein operation of the motor causes movement of the sunshade, a second position wherein operation of the motor causes movement of the sunroof glass, and a third position wherein operation of the motor causes simultaneous movement of the sunroof glass and the sunshade.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle equipped with a sunroof glass system in accordance with an exemplary embodiment;

FIG. 2 illustrates a sunroof system having a sunroof glass and a sunshade in accordance with an exemplary embodiment;

FIG. 3 illustrates a sunroof system with a single motor for controlling both the sunroof glass and sunshade in accordance with an exemplary embodiment;

FIG. 4 illustrates a cross-sectional view of a motor assembly of the sunroof control system in accordance with an exemplary embodiment;.

FIG. 5A illustrates a cross-sectional view of the sunroof control system having a clutch in a first position to control the sunshade in accordance with an exemplary embodiment;

FIG. 5B illustrates a cross-sectional view of the sunroof control system having a clutch in a second position to control the sunroof glass in accordance with an exemplary embodiment;

FIG. 5C illustrates a cross-sectional view of the sunroof control system having a clutch in a third position to simultaneously control the sunshade and the sunroof glass in accordance with an exemplary embodiment;

FIG. 5D illustrates a cross-sectional view of clutch of the sunroof control system in accordance with an exemplary embodiment;

FIG. 6 illustrates cross-sectional views of a preconditioning process for aligning the clutch mechanism of the sunroof system in accordance with an exemplary embodiment;

FIG. 7 illustrates a block diagram of a control system for operating the sunroof glass and sunshade using a single motor in accordance with an exemplary embodiment;

FIG. 8 depicts a flow chart diagram of the method for operating the sunshade in accordance with an exemplary embodiment; and

FIG. 9 illustrates a flow chart diagram of the method for adjusting the sunroof glass position in accordance with an exemplary embodiment.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

Automotive sunroof systems often incorporate multiple motors to control various components, such as the sunroof glass and sunshade. This configuration typically involves separate motors for each function, leading to increased complexity and weight. The use of multiple motors requires additional components, including wires and electronic controls, which can contribute to potential failure points within the system. The complexity of managing these separate mechanisms can result in reliability issues, as the increased number of components elevates the likelihood of malfunction. Existing sunroof systems with separate motors for the sunroof glass and sunshade present several disadvantages. The need for multiple motors and associated components adds to the overall weight and complexity of the vehicle.

The disclosed sunroof system addresses these challenges by integrating a single motor with an electromagnetically controlled clutch to control both the sunroof glass and the sunshade. This design reduces the number of motors required, simplifying the sunroof system by decreasing the number of components. The electromagnetically controlled clutch allows for selective engagement between a motor and the sunroof glass and sunshade, providing efficient control over both functions. By incorporating a pre-conditioning phase, the sunroof control system provides smooth transitions between the different modes of operation, enhancing reliability and functionality.

In accordance with an exemplary embodiment a sunroof system for a vehicle having a single motor configured to control both the sunshade and the sunroof glass is provided. In exemplary embodiments, the sunroof system includes an electromagnetically controlled clutch that is configured to selectively connect the motor to the sunshade and the sunroof glass, thereby reducing the number of motors needed to control the sunshade and the sunroof glass. In exemplary embodiments, the sunroof system is configured to pre-condition the clutch movement using gear backlash and pinion alignment to ensure a smooth transition between operational modes. This single motor design reduces complexity and weight of the sunroof system while enhancing reliability and functionality.

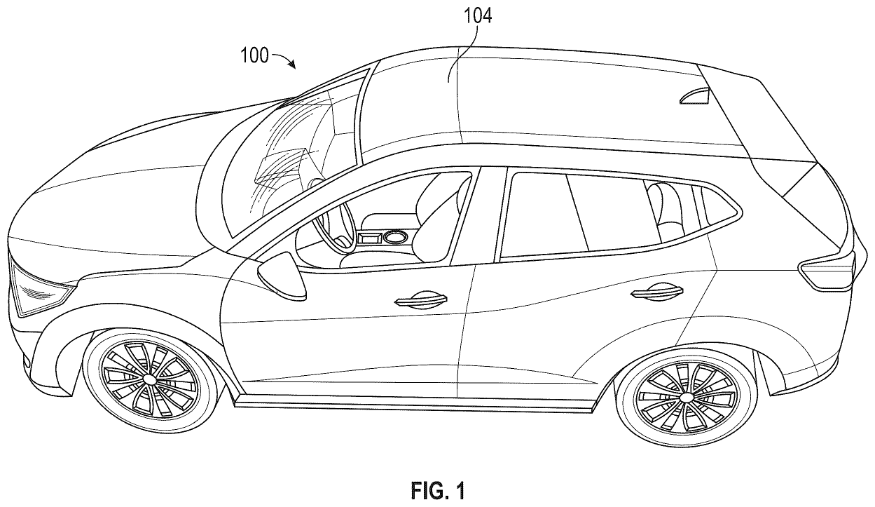

FIG. 1 shows a vehicle 100 equipped with a sunroof glass 104. The vehicle 100 serves as the primary structure within which the sunroof system operates, integrating various components to enhance functionality and user experience. The vehicle 100 provides the framework and support for the sunroof system, accommodating the sunroof glass 104 within the roof structure of the vehicle 100. The design of the vehicle 100 allows for the integration of the sunroof system, ensuring compatibility with the vehicle's overall architecture and design. The sunroof glass 104 is positioned within the roof of the vehicle 100, offering an opening to the exterior environment. In exemplary embodiments, the sunroof glass 104 is designed to slide or tilt, providing ventilation and natural light to the interior of the vehicle 100. The integration of the sunroof glass 104 within the vehicle 100 enhances the aesthetic appeal and functionality of the vehicle.

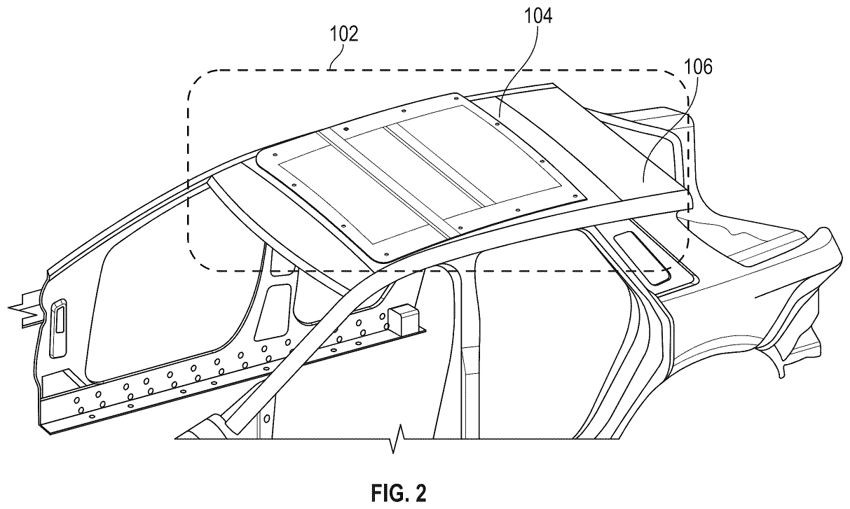

FIG. 2 shows a sunroof system 102 integrated into a vehicle structure. The sunroof system 102 includes a sunroof glass 104 and a sunshade 106. The sunroof system 102 is designed to enhance the vehicle's functionality by providing an opening to the exterior environment. The sunroof glass 104 is positioned within the roof of the vehicle, allowing for sliding or tilting movements. This configuration provides ventilation and natural light to the vehicle's interior. In exemplary embodiments, the sunroof glass 104 is integrated seamlessly into the vehicle's design, contributing to both aesthetic appeal and functionality. The sunshade 106 is located beneath the sunroof glass 104. The sunshade 106 offers additional control over light and privacy within the vehicle. In exemplary embodiments, the sunshade 106 can be adjusted independently to block sunlight or provide shade, enhancing the comfort of the vehicle's occupants.

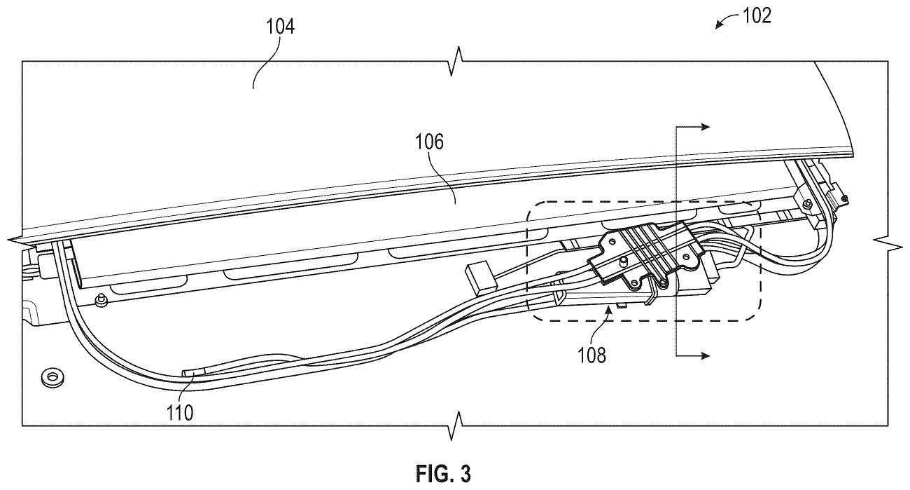

FIG. 3 shows a sunroof system 102 with integrated components for controlling both the sunroof glass 104 and the sunshade 106. The sunroof system 102 includes a motor 108 and cables 110, which facilitate the operation of the sunroof glass 104 and the sunshade 106. The motor 108 is responsible for driving the movement of both the sunroof glass 104 and the sunshade 106. The motor 108 operates through a series of mechanisms that allow for precise control of the sunroof system 102. The cables 110 connect the motor 108 to the sunroof glass 104 and the sunshade 106. These cables 110 transmit the necessary force from the motor 108 to the respective components, enabling their movement.

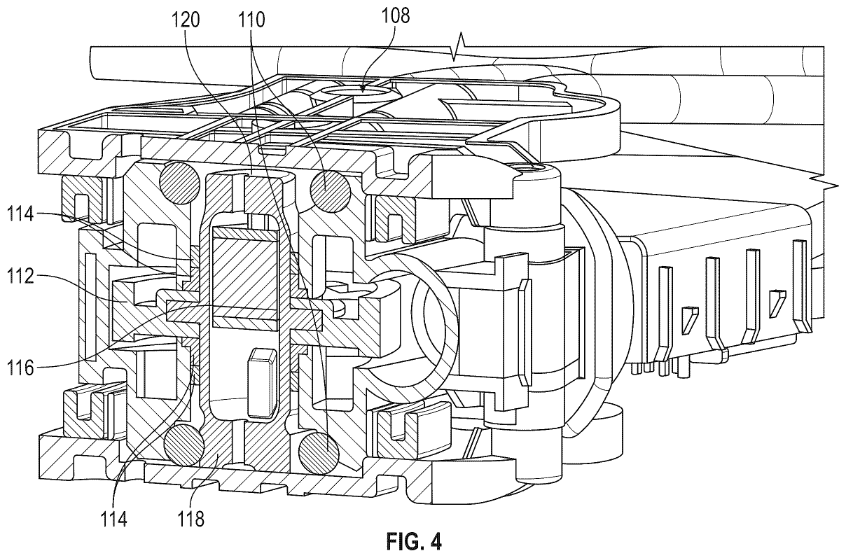

FIG. 4 shows a cross-sectional view of the motor 108 in accordance with an exemplary embodiment. The motor 108 includes cables 110, a pinion gear 112, bearings 114, a clutch 116, a pinion for sunshade 118, and a pinion for glass 120. In exemplary embodiments, the pinion gear 112 interacts with a worm gear (not shown) of the motor 108 to facilitate movement of the clutch 116. In exemplary embodiments, the pinion gear 112 selectively engages with other gears via the clutch 116 to transmit rotational motion. In exemplary embodiments, the bearings 114 support the rotational movement of the pinion gear 112, reducing friction and wear. The bearings 114 ensures smooth and efficient operation of the gear system.

In exemplary embodiments, the pinion for sunshade 118 connects to the sunshade, enabling the movement of the sunshade. The pinion for sunshade 118 selectively engages with the clutch 116 to provide precise control over the position of the sunshade. Likewise, the pinion for glass 120 connects to the sunroof glass, facilitating the movement of the sunroof glass. The pinion for glass 120 selectively engages with the clutch 116 to provide precise control over the position of the sunroof glass. In exemplary embodiments, the clutch 116 is configured to selectively engage and disengage the pinion gear 112 with the pinion for sunshade 118 and the pinion for glass 120.

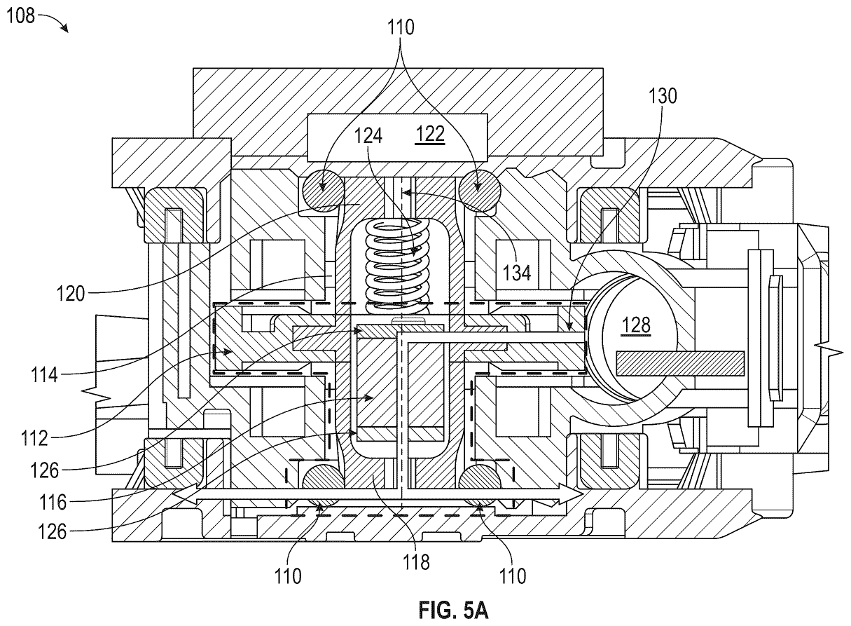

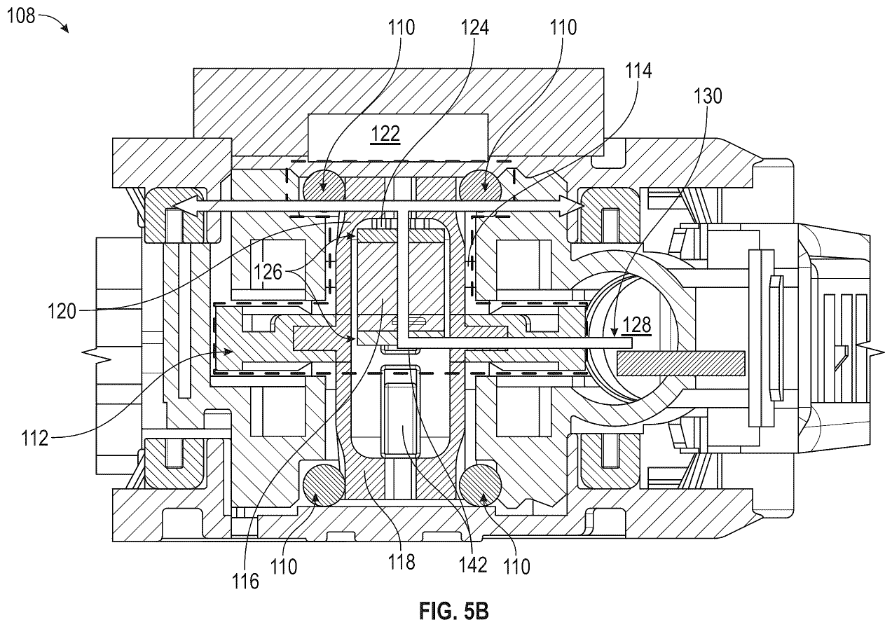

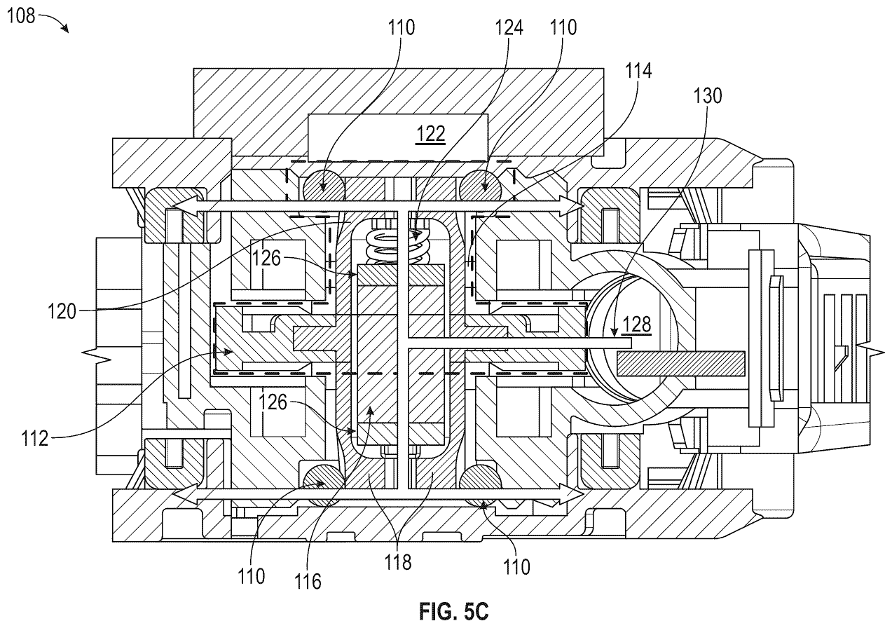

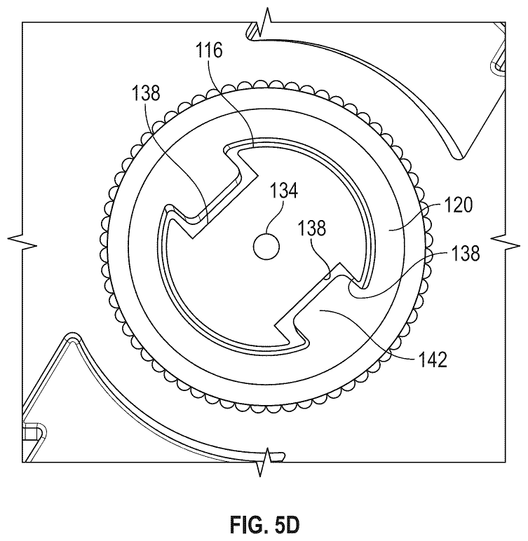

Referring now to FIGS. 5A, 5B and 5C cross-sectional views of the motor of the sunroof control system are shown. In exemplary embodiments, the motor 108 includes an electromagnet 122, a spring 124, and one or more permanent magnets 126 that are utilized to control a position of the clutch 116 within the motor 108.

In exemplary embodiments, the electromagnet 122 controls the engagement of the clutch 116 with the pinion for sunshade 118 and the pinion for glass 120. The electromagnet 122 provides the necessary force to move the clutch 116 and selectively engage the pinion for glass 120 and the pinion for sunshade 118. In exemplary embodiments, the electromagnet 122 receives an electrical current and responsively creates an electromagnetic field. In exemplary embodiments, the strength of electromagnetic field created by the electromagnet 122 is controlled based on the strength of the electrical current provided to the electromagnet 122.

In exemplary embodiments, the clutch 116 includes one or more permanent magnets 126 that interact with the electromagnetic field created by the electromagnet 122 to control the position of the clutch 116. In one embodiment, the permanent magnets 126 include a first magnet disposed on one end of the clutch 116 and a second magnet disposed on a second end, which is opposite to the first end of the clutch 116. In exemplary embodiments, a spring 124 is disposed between the electromagnet 122 and the clutch 116. The spring 124 assists in controlling the position of the clutch 116. For example, the spring 124 is configured to control the position of the clutch 116 when the electromagnet 122 is deactivated.

In exemplary embodiments, as depicted in FIG. 5A, when the electromagnet 122 is deactivated, the spring 124 exerts force on the clutch 116, moving the clutch 116 into a first position. In the first position, the clutch 116 engages with the pinion for sunshade 118, allowing the motor 108 to control the movement of the sunshade. The spring 124 provides the necessary tension to maintain the clutch 116 in this position, ensuring that the sunshade can be operated smoothly and reliably. This configuration allows for efficient control of the sunshade, utilizing mechanical force to engage the necessary components.

In an alternative embodiment, the spring 124 may be replaced with a permanent magnet that is affixed to a side of the motor housing. This permanent magnet provides the necessary tension to maintain the clutch 116 in the first position when the electromagnet 122 is deactivated. When the electromagnet 122 is turned off, the magnetic force from the permanent magnet attracts the clutch 116, moving it into the first position. In the first position, the clutch 116 engages with the pinion for sunshade 118, allowing the system to control the movement of the sunshade. The permanent magnet ensures that the clutch 116 remains securely engaged with the pinion for sunshade 118, providing reliable. This configuration offers an efficient and durable solution, utilizing magnetic force to maintain the clutch position, thereby reducing mechanical wear and enhancing the system's longevity.

In exemplary embodiments, as shown in FIG. 5B, when the electromagnet 122 is activated, the electromagnet 122 generates an electromagnetic field that interacts with the permanent magnets 126. This interaction creates an attractive force strong enough to overcome the opposing force of the spring 124. As a result, the clutch 116 is pulled into a second position. In the second position, the clutch 116 engages with the pinion for glass 120, enabling control over the movement of the sunroof glass. This mechanism allows for precise and efficient operation of the sunroof glass, utilizing electromagnetic force to achieve the desired engagement and movement.

In exemplary embodiments, as shown in FIG. 5C, the electromagnetic force generated by the electromagnet 122 is precisely controlled to position the clutch 116 in a third position. In the third position, the clutch 116 simultaneously engages with both the pinion for sunshade 118 and the pinion for glass 120. This dual engagement allows for the concurrent movement of the sunshade and the sunroof glass, providing synchronized control over both components. To achieve this simultaneous engagement, the size of the clutch 116 may need to be larger to effectively span and connect with both the pinion for glass 120 and the pinion for sunshade 118 while also being able to selectively disengage from either the pinion for glass 120 or the pinion for sunshade 118.

In the embodiment shown in FIG. 5C, the sunroof system employs a clutch mechanism that can engage with both the pinion for the sunroof glass and the pinion for the sunshade. This dual engagement occurs when the clutch is positioned in a third position, allowing simultaneous control over both components. The motor 108 utilizes an electromagnet 122 to achieve this functionality, with the electromagnet's activation level determining the position of the clutch. For example, when the electromagnet 122 receives a first current level, the clutch 116 moves to a second position, engaging solely with the pinion for the sunroof glass 120. Conversely, when the electromagnet 122 is activated with a second current level, which is less than the first, the clutch 116 transitions to the third position. In this state, the clutch 116 simultaneously engages with both the pinion for the sunroof glass 120 and the pinion for the sunshade 118. This configuration enables synchronized movement of the sunroof glass and sunshade, providing enhanced control and functionality within the sunroof system.

In exemplary embodiments, the motor 108 also includes a worm gear 128 that provides torque to the pinion gear 112. As illustrated by the torque flows 130 shown in FIGS. 5A, 5B, and 5C, the pinion gear 112 transmits the torque from the worm gear 128 to the clutch 116, which selectively provides torque to one or more of the pinion for glass 120 and the pinion for sunshade 118.

FIG. 5D shows a cross-section view of the clutch 116 within the motor. In exemplary embodiments, the axis of clutch 134 serves as the central rotational axis for the clutch 116. This axis provides the necessary support and alignment for the clutch 116, ensuring smooth and efficient operation. In exemplary embodiments, the clutch 116 includes one or more grooves 138 that are configured to selectively engage with spines 142 that are disposed on the pinion for glass 120 and the pinion for sunshade 118 (not shown).

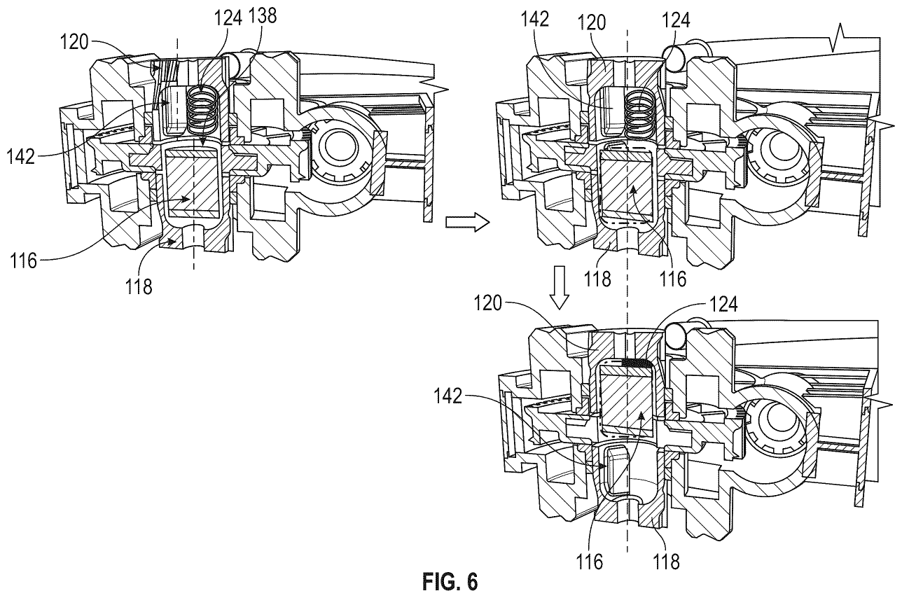

FIG. 6 shows a cross-sectional view of a sunroof control system illustrating the pre-conditioning and movement of a clutch 116. The sunroof control system includes a clutch, a pinion for sunshade 118, a pinion for glass 120, a spring 124, spines 142, and grooves 138 on the clutch 116. The clutch 116 is configured to selectively engagement with the pinion for sunshade 118 and the pinion for glass 120. The clutch 116 moves between different positions to control the sunroof glass and sunshade, guided by the spring 124 and an electromagnet. In exemplary embodiments, spines 142 are disposed on the pinion for sunshade 118 and the pinion for glass 120 and provides structural support and alignment for the clutch 116, ensuring efficient operation. The spines 142 interact with the grooves 138 on the clutch 116 to facilitate the clutch 116 movement and engagement with the pinion for sunshade 118 and the pinion for glass 120.

In FIG. 6, the pre-conditioning process ensures that the clutch 116 transitions smoothly between the first and second positions by aligning the spines 142 and grooves 138. As the clutch 116 moves, s control system uses a combination of mechanical and electromagnetic forces to achieve precise alignment. Initially, the spring 124 exerts force on the clutch 116, guiding it towards the desired position. During this transition, the spines 142, located on the pinion for sunshade 118 and pinion for glass 120, interact with the grooves 138 on the clutch 116. This interaction maintains alignment and ensuring that the clutch 116 engages correctly with the respective pinion. The electromagnet provides additional control by generating a magnetic field that influences the movement of the clutch 116. This electromagnetic force helps fine-tune the alignment, ensuring that the spines 142 fit seamlessly into the grooves 138. The pre-conditioning phase allows for any necessary adjustments, compensating for potential gear backlash and ensuring a smooth transition. By carefully coordinating the forces exerted by the spring 124 and the electromagnet, the system achieves precise alignment of the clutch 116, enabling efficient and reliable operation of both the sunroof glass and sunshade.

In an alternative embodiment, the sunroof control system eliminates the use of a spring and instead employs two electromagnets positioned on opposite sides of the clutch 116 to control the position of the clutch. This configuration allows for precise control over the engagement of the clutch with the pinion for sunshade 118 and the pinion for glass 120. When a first electromagnet is activated, it generates a magnetic field that attracts the clutch 116 towards the pinion for sunshade 118. This engagement allows the system to control the movement of the sunshade. Conversely, when a second electromagnet is activated, it creates a magnetic field that pulls the clutch 116 towards the pinion for glass 120, enabling control over the sunroof glass. The dual electromagnet setup provides flexibility and precision in controlling the clutch position, allowing for rapid switching between sunshade and sunroof glass operations. This design enhances the system's responsiveness and eliminates the need for mechanical components like springs, potentially reducing wear and maintenance requirements.

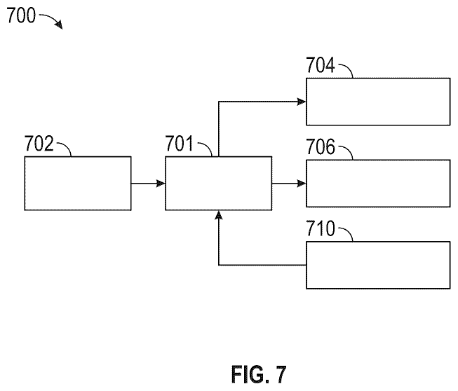

Referring now to FIG. 7, a block diagram 700 of a control system for operating the sunroof glass and sunshade using a single motor in accordance with an exemplary embodiment is shown. The control system includes a processing device 701 that serves as the central control unit within the sunroof system. The processing device 701 manages the coordination and execution of commands related to the operation of the sunroof glass and sunshade. The processing device 701 receives input signals from various components and processes these signals to determine the appropriate actions. The processing device 701 interfaces with other components, such as a user interface 702, a motor controller 706, the electromagnet 704, and sensors 710, to ensure proper operation of the sunroof system. The processing device 701 may include a microprocessor or microcontroller capable of executing software instructions to perform the functions of the processing device 701.

In exemplary embodiments, the user interface 702 provides a means for the vehicle occupant to interact with the sunroof system. The user interface 702 allows the user to input commands to open or close the sunroof glass and sunshade. The user interface 702 may include buttons, touchscreens, or other input devices that communicate with the processing device 701. The user interface 702 sends user commands to the processing device 701, which then processes these commands to control the sunroof system's operation.

In exemplary embodiments, the electromagnet 704 is configured to control the position of the clutch within the sunroof system. The electromagnet 704 generates a magnetic field in response to electrical signals received from the processing device 701. The electromagnet 704 interacts with permanent magnets attached to the clutch, enabling the selective engagement of the clutch with the pinion gears for the sunroof glass and sunshade. The operation of the electromagnet 704 is required for switching between the sunroof glass and sunshade functions, as the electromagnet 704 provides the necessary force to move the clutch into the desired position.

In exemplary embodiments, the motor controller 706 regulates the operation of the motor that drives the sunroof glass and sunshade. The motor controller 706 receives control signals from the processing device 701 and adjusts the motor's speed and direction accordingly. The motor controller 706 ensures that the motor operates efficiently and responds accurately to user commands. The motor controller 706 may include power electronics and control algorithms to manage the motor's performance, providing precise control over the sunroof system's movement.

In exemplary embodiments, the sensor(s) 710 provide feedback to the processing device 701 regarding the position and status of the sunroof glass and sunshade. The sensor(s) 710 may include position sensors, limit switches, or other types of sensors that detect the current state of the sunroof components, such as the clutch, the pinion for the sunshade, and the pinon for the sunroof glass. The sensor(s) 710 send data to the processing device 701, allowing the processing device to make informed decisions about the operation of the sunroof system. The sensor(s) 710 play a role in ensuring the system operates safely and efficiently by providing real-time information about the sunroof's position. In exemplary embodiments, the processing device 701 is configured to precondition the clutch to facilitate movement between engagement with the pinion for the sunshade and the pinon for the sunroof glass.

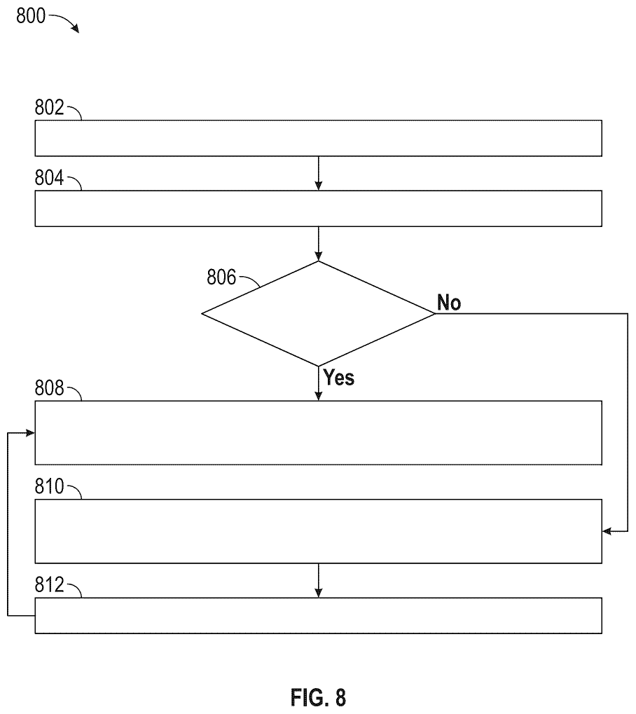

Referring now to FIG. 8, a flow chart diagram of a method 800 for operating the sunshade in accordance with an exemplary embodiment is shown. In exemplary embodiments, the method 800 is performed by the processing device 701, shown in FIG. 7. The method 800 begins at block 802 by receiving a request to change a position of a sunshade. The input signal may originate from a user interface or an automated control system. Next, at block 804, the method 800 includes determining a position of the clutch. In exemplary embodiments, one or more sensors may be used to assess the current position of the clutch 116 within the sunroof system.

As decision block 806, it is determined whether clutch in a first position (i.e., whether the clutch is engaged with the pinion for the sunshade). Based on a determination that the clutch 116 is in the first position, the method proceeds to block 808 and activates the motor to achieve the desired change in the position of the sunshade. Based on a determination that clutch 116 is not in the first position, the method proceeds to block 810 and preconditions the clutch to align the groove of the clutch with a spine of the pinon for the sunshade. In exemplary embodiments, the preconditioning step ensures that the clutch 116 can engage seamlessly, minimizing wear and enhancing operational efficiency.

At block 812, the method 800 includes deactivating the electromagnet to move the clutch to the first position. In exemplary embodiments, deactivating the electromagnet 122 allows a spring 124 to exert force on the clutch 116, which moves the clutch 116 into the first position, engaging the clutch 116 with the pinion for sunshade 118.

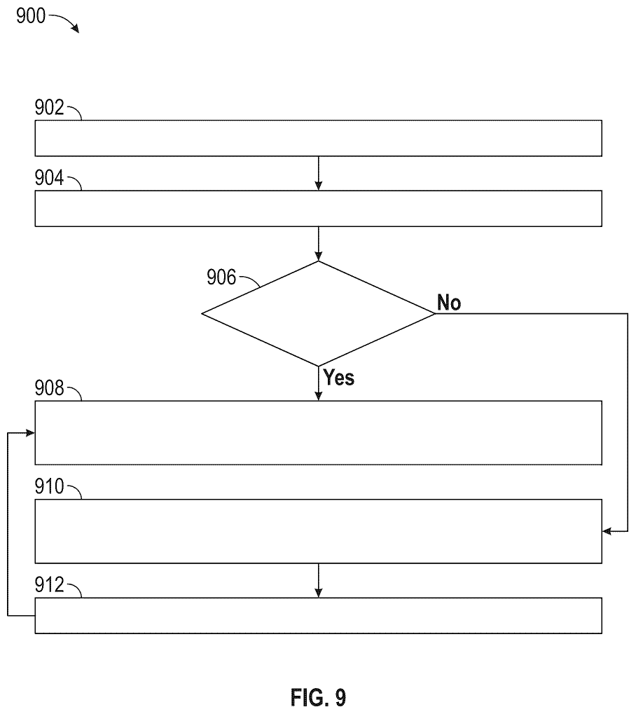

Referring now to FIG. 9, a flow chart diagram of a method 900 for operating the sunshade in accordance with an exemplary embodiment is shown. In exemplary embodiments, the method 900 is performed by the processing device 701, shown in FIG. 7. The method 900 begins at block 902 by receiving a request to change the position of the sunroof glass. In exemplary embodiments, the request may originate from a user interface or an automated control system, signaling the need to adjust the sunroof glass. Next, at step 904, the method 900 determines the position of the clutch. In exemplary embodiments, sensors within the sunroof system are configured to determine the current position of the clutch.

At step 906, the method 900 evaluates whether the clutch is in a second position, which corresponds to engagement with the pinion for the sunroof glass. Based on a determination that the clutch is in the second position, the method proceeds to block 908 and activates the motor to achieve the desired change in the position of the sunroof glass. The motor drives the movement of the sunroof glass to the requested position.

Based on a determination that the clutch is not in the second position, the method 900 proceeds to step 910, where the method preconditions the clutch. In exemplary embodiments, the preconditioning step involves aligning the groove of the clutch with a spine of the pinion for the sunroof glass, ensuring seamless engagement. Next, at block 912, the method 900 activates the electromagnet to move the clutch to the second position. In exemplary embodiments, the electromagnet generates a magnetic field that positions the clutch for engagement with the pinion for the sunroof glass, enabling the desired adjustment.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for controlling a sunroof system in a vehicle, comprising:
a motor configured to drive a sunroof glass and a sunshade;
a clutch operatively connected to the motor, the clutch configured to selectively engage with a pinion for the sunroof glass and a pinion for the sunshade;
an electromagnet disposed on one side of the clutch; and
a spring positioned to maintain the clutch in a first position for sunshade operation when the electromagnet is deactivated,
wherein the electromagnet, when activated, moves the clutch to a second position to engage with the pinion for the sunroof glass.

2. The system of claim 1, further comprising a processing device that is configured to align one or more grooves on the clutch and pinion gears prior to a movement of the clutch between the first position and second position to ensure smooth transitions between sunroof glass and sunshade operations.

3. The system of claim 2, wherein the processing device is configured to obtain data from one or more sensors to detect a position of the clutch.

4. The system of claim 1, wherein the clutch includes a permanent magnet disposed on one end of the clutch.

5. The system of claim 1, wherein a strength of an electromagnetic filed created by the electromagnet is determined based on an electrical current supplied to the electromagnet.

6. The system of claim 1, wherein the spring is configured to exert a force sufficient to maintain the clutch in the first position while the electromagnet is deactivated.

7. The system of claim 1, wherein the clutch is further configured to simultaneously engage with the pinion for the sunroof glass and the pinion for the sunshade while in a third position.

8. The system of claim 7, wherein activating the electromagnet with a first current level moves the clutch to the second position to engage the sunroof glass and activating the electromagnet with a second current level moves the clutch to the third position to with the pinion for the sunroof glass and the pinion for the sunshade, wherein the second current level is less than the first current level.

9. The system of claim 1, wherein the clutch includes one or more grooves that are configured to receive the pinion for the sunroof glass and the pinion for the sunshade.

10. A vehicle comprising:
a sunroof system having a sunroof glass and a sunshade;
a control system for controlling the sunroof system, the control system comprising:
a motor configured to drive the sunroof glass and the sunshade;
a clutch operatively connected to the motor, the clutch configured to selectively engage with a pinion for the sunroof glass and a pinion for the sunshade;
an electromagnet disposed on one side of the clutch; and
a spring positioned to maintain the clutch in a first position for sunshade operation when the electromagnet is deactivated,
wherein the electromagnet, when activated, moves the clutch to a second position to engage with the pinion for the sunroof glass.

11. The vehicle of claim 10, wherein the control system further comprises a processing device that is configured to align one or more grooves on the clutch and pinion gears prior to a movement of the clutch between the first position and second position to ensure smooth transitions between sunroof glass and sunshade operations.

12. The vehicle of claim 11, wherein the processing device is configured to obtain data from one or more sensors to detect a position of the clutch.

13. The vehicle of claim 10, wherein the clutch includes a permanent magnet disposed on one end of the clutch.

14. The vehicle of claim 10, wherein a strength of an electromagnetic filed created by the electromagnet is determined based on an electrical current supplied to the electromagnet.

15. The vehicle of claim 10, wherein the spring is configured to exert a force sufficient to maintain the clutch in the first position while the electromagnet is deactivated.

16. The vehicle of claim 10, wherein the clutch is further configured to simultaneously engage with the pinion for the sunroof glass and the pinion for the sunshade while in a third position.

17. The vehicle of claim 16, wherein activating the electromagnet with a first current level moves the clutch to the second position to engage the sunroof glass and activating the electromagnet with a second current level moves the clutch to the third position to with the pinion for the sunroof glass and the pinion for the sunshade, wherein the second current level is less than the first current level.

18. The vehicle of claim 10, wherein the clutch includes one or more grooves that are configured to receive the pinion for the sunroof glass and the pinion for the sunshade.

19. A system for controlling a sunroof system in a vehicle, comprising:
a motor configured to drive a sunroof glass and a sunshade;
a clutch operatively connected to the motor, the clutch configured to selectively engage with a pinion for the sunroof glass and a pinion for the sunshade;
an electromagnet disposed on one side of the clutch; and
a processing device configured to control a current suppled to the electromagnet, wherein an electromagnetic field created by the electromagnet interacts with the clutch to control a position of the clutch,
wherein the processing device is configured to selectively place the clutch into a first position wherein operation of the motor causes movement of the sunshade and into a second position for wherein operation of the motor causes movement of the sunroof glass.

20. The system of claim 19, wherein the processing device is configured to selectively place the clutch into a third position wherein operation of the motor causes simultaneous movement of the sunroof glass and the sunshade.
